(19) United States
(12) Patent Application Publication
(10) Pub. No.: US 2024/0107491 A1
(43) Pub. Date: Mar. 28, 2024

(54) METHOD AND DEVICE FOR DEVICE POSITIONING IN COMMUNICATION SYSTEM

(71) Applicant: Samsung Electronics Co., Ltd., Gyeonggi-do (KR)

(72) Inventors: Xiong QI, Beijing (CN); Pengru LI, Beijing (CN); Feifei SUN, Beijing (CN)

(21) Appl. No.: 18/471,860

(22) Filed: Sep. 21, 2023

(30) Foreign Application Priority Data
Sep. 28, 2022 (CN) 202211196026.9

(51) Int. Cl. H04W 64/00; H04L 5/00; H04W 56/00

(52) U.S. Cl. CPC H04W 64/00; H04L 5/0051; H04W 56/0015

(57) ABSTRACT

The disclosure relates to a fifth generation (5G) or sixth generation (6G) communication system for supporting a higher data transmission rate. Disclosed is a method performed by a first device in a communication system, including performing measurement of a first reference signal based on configuration information for the first reference signal, when the first device meets a predetermined condition, and reporting a result of the measurement, wherein the predetermined condition is based on at least one of location information, information related to downlink reference signals, and information related to at least one base station.

### CROSS-REFERENCE TO RELATED APPLICATION(S)

This application is based on and claims priority under 35 U.S.C. § 119(a) to Chinese Patent Application No. 202211196026.9, which was filed in the China National Intellectual Property Administration on Sep. 28, 2022, the entire disclosure of which is incorporated herein by reference.

### BACKGROUND

### 1. Field

The disclosure relates generally to a method and device for positioning in a wireless communication system, and more particularly, to a method and device for improving positioning performance in communication systems to minimize or restore time synchronization error and/or phase synchronization error.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Conventionally, however, the positioning performance in wireless communication systems is unreliable and inconsistent. As such, there is a need in the art for a method to improve the positioning performance of the system. The resulting positioning-related information with higher quality may be used to improve the performance of the network, which is also deficient due to the positioning performance shortcomings in the system. For example, in conventional wireless communication systems, when a time synchronization error and/or phase synchronization error between transmission-reception points (TRPs) or base stations is relatively large, the positioning performance is significantly compromised. Thus, there is a need in the art for an improvement the positioning performance in communication systems to minimize or restore time synchronization error and/or phase synchronization error as much as possible.

### SUMMARY

The disclosure has been made to address at least the above-mentioned problems and/or disadvantages and to provide at least the advantages described below.

Accordingly, an aspect of the disclosure is to provide a method and apparatus for improving the positioning performance of a communication system.

An aspect of the disclosure is to provide a method for positioning to be used for calibrating synchronization errors.

An aspect of the disclosure is to provide a method for positioning which provides positioning reference units enabled for positioning measurement when the network condition changes.

An aspect of the disclosure is to provide a method for positioning in which synchronization can be calibrated by utilizing more detailed positioning-related information than in the conventional art, which may be used to adjust the network, thereby optimizing the network performance.

In accordance with an aspect of the disclosure, a method performed by a first device in a communication system includes performing measurement of a first reference signal based on configuration information for the first reference signal, when the first device meets a predetermined condition, and reporting a result of the measurement, wherein the predetermined condition is based on at least one of location information, information related to downlink reference signals, and information related to at least one base station

In accordance with an aspect of the disclosure, a method performed by a second device in a communication system includes sending configuration information for a first reference signal to at least one first device meeting a predetermined condition, and receiving a result of measurement of the first reference signal from one or more of the at least one first devices, wherein the predetermined condition is based on at least one of location information, information related to downlink reference signals, and information related to at least one base station.

In accordance with an aspect of the disclosure, a device in a communication system includes a transceiver configured to transmit and/or receive signals, and a processor configured to perform a method in a communication system, the method including sending configuration information for a first reference signal to at least one first device meeting a predetermined condition, and receiving a result of measurement of the first reference signal from one or more of the at least one first devices, wherein the predetermined condition is based on at least one of location information, information related to downlink reference signals, and information related to at least one base station.

### BRIEF DESCRIPTION OF THE DRAWINGS

The foregoing and other aspects, features and advantages of certain embodiments of the present disclosure will become more apparent from the following description with reference to the accompanying drawings, in which:

FIG. 1 illustrates a wireless network according to an embodiment;

FIG. 2A illustrates a wireless transmission path according to an embodiment;

FIG. 2B illustrates a wireless reception path according to an embodiment;

FIG. 3A illustrates a user equipment according to an embodiment;

FIG. 3B illustrates a base station according to an embodiment;

FIG. 4 illustrates a method of positioning by a device according to an embodiment; and

FIG. 5 illustrates a device in a communication system according to an embodiment.

### DETAILED DESCRIPTION

The following description with reference to the accompanying drawings is provided to assist in a comprehensive understanding of embodiments of the present disclosure. It includes specific details to assist in that understanding but these are merely examples. Accordingly, those of ordinary skill in the art will recognize that changes and modifications of the embodiments described herein can be made without departing from the scope and spirit of the present disclosure. In addition, descriptions of well-known functions and constructions may be omitted for the sake of clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of embodiments of the present disclosure is provided for illustration purposes only and not for the purpose of limiting the present disclosure.

Singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in embodiments of the present disclosure and does not limit the existence of one or more additional functions, operations, or components. The terms such as “include” and/or “have” may be construed to denote a certain characteristic, number, step, operation, constituent element, component or a combination thereof, but may not be construed to exclude the possibility of existence of one or more other characteristics, numbers, steps, operations, constituent elements, components or combinations thereof.

The term “or” used in embodiments of the present disclosure includes any or all of combinations of listed words. For example, the expression “A or B” may include A, may include B, or may include both A and B.

The term “comprise” used herein refers to the presence of said features, integers, steps, operations, elements and/or components, but does not exclude the presence or addition of one or more other features, integers, steps, operations, elements, components and/or groups thereof. It should be understood that when it is said that an element is “connected” or “coupled” to another element, it may be directly connected or coupled to the other element, or there may be an intervening element. Furthermore, “connect” or “couple” as used herein may include wireless connection or wireless coupling. The phrase “and/or” as used herein includes all or any of units and all combinations of one or more associated listed items.

Unless otherwise defined, all terms (including technical terms and scientific terms) as used herein have the same meaning as commonly understood by those skilled in the art to which the present application pertains. It should also be understood that terms, such as those defined in universal dictionaries, should be understood to have meanings consistent with those in the context of the prior art, and will not be interpreted in an idealized or overly formal sense, unless specifically defined herein.

The terms “terminal” and “terminal equipment” used herein include both a device of wireless signal receiver, which only has a device of wireless signal receiver without transmission capability, and a device of receiving and transmitting hardware, which has a device of receiving and transmitting hardware capable of bidirectional communication on bidirectional communication link. Such devices may include, a cellular or other communication device, which has a single-line display or a multi-line display, or does not have a multi-line display, personal communications service (PCS), which may combine voice, data processing, fax and/or data communication capabilities, a personal digital assistant (PDA), which may include an RF receiver, pager, Internet/Intranet access, web browser, notepad, calendar and/or a global positioning system (GPS) receiver, and a conventional laptop and/or palmtop computer or other device, which has and/or includes a radio frequency receiver. As used herein, “terminal” and “terminal equipment” can be portable, transportable, installed in vehicles (aviatic, marine and/or terrestrial), or suitable and/or configured to operate locally, and/or operate in any other location on the earth and/or space in a distributed manner. As used herein, “terminal” and “terminal equipment” can also be communication terminal, Internet terminal and music/video playing terminal, such as the PDA, a mobile Internet device (MID) and/or mobile phone with music/video playing function, as well as smart television (TV), set-top box and other devices.

Without departing from the scope of the present invention, the term “send” herein can be used interchangeably with “transmit”, “report” and “notify”.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art and are not to be interpreted to have ideal or excessively formal meanings unless clearly defined in the present disclosure.

Technical schemes of embodiments herein may be applied to communication systems, such as global system for mobile communications (GSM) system, code division multiple access (CDMA) system, wideband CDMA (WCDMA) system, general packet radio service (GPRS), long term evolution (LTE) system, LTE frequency division duplex (FDD) system, LTE time division duplex (TDD) system, universal mobile telecommunications system (UMTS), worldwide interoperability for microwave access (WiMAX) communication system, 5G system or new radio (NR), etc. In addition, the technical schemes of embodiments of the disclosure may be applied to future-oriented communication technologies.

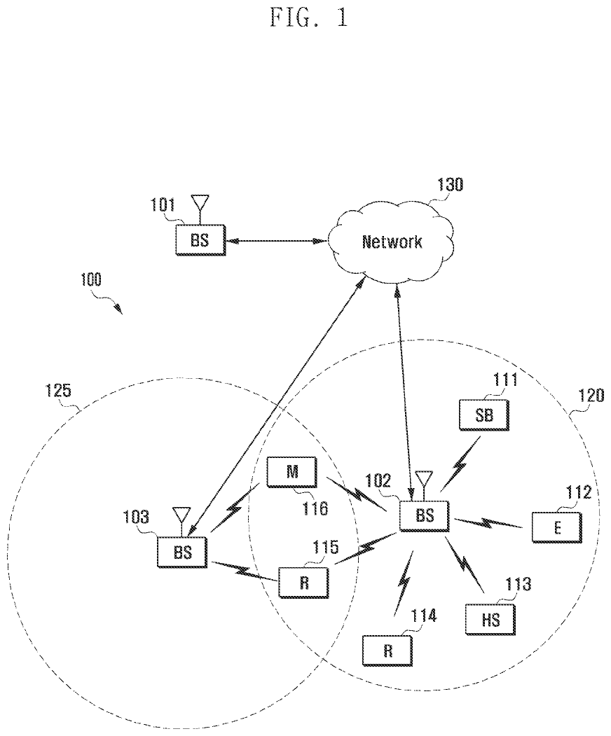

FIG. 1 illustrates an example wireless network 100 according to an embodiment.

Referring to FIG. 1, the wireless network 100 includes a gNodeB (gNB) or BS 101, a gNB or BS 102, and a gNB or BS 103. The gNB 101 communicates with gNB 102 and gNB 103 and also communicates with at least one Internet protocol (IP) network 130, such as the Internet, a private IP network, or other data networks.

Depending on a type of the network, other well-known terms such as an access point can be used instead of BS or gNB. For convenience, the terms gNodeB and gNB are used herein to refer to network infrastructure components that provide wireless access for remote terminals. Depending on the type of the network, other well-known terms such as mobile station, user station, remote terminal, wireless terminal or user apparatus can be used instead of user equipment (UE). For convenience, the terms user equipment and UE are used to refer to remote wireless devices that wirelessly access the gNB, regardless of whether the UE is a mobile device such as a mobile phone or a smart phone) or a fixed device such as a desktop computer or a vending machine.

The gNB 102 provides wireless broadband access to the network 130 for a first plurality of UEs within a coverage area 120 of gNB 102. The first plurality of UEs include UE 111, which may be located in a small business (SB), UE 112, which may be located in an enterprise (E), UE 113, which may be located in a wireless fidelity (WiFi) hotspot (HS), UE 114, which may be located in a first residence (R), UE 115, which may be located in a second residence (R), UE 116, which may be a mobile device (M), such as a cellular phone, a wireless laptop computer, a wireless PDA, etc. The gNB 103 provides wireless broadband access to network 130 for a second plurality of UEs within a coverage area 125 of gNB 103. The second plurality of UEs include UE 115 and UE 116. One or more of gNBs 101-103 can communicate with each other and with UEs 111, 112, 113, 114, 115 and 116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration purposes. It should be clearly understood that the coverage areas associated with the gNBs, such as the coverage areas 120 and 125, may have other shapes depending on configurations of the gNBs and changes in the radio environment associated with natural and man-made obstacles.

One or more of gNB 101, gNB 102, and gNB 103 include a two-dimensional (2D) antenna array and support codebook designs and structures for systems with 2D antenna arrays.

Although FIG. 1 illustrates an example of the wireless network 100, various changes can be made to FIG. 1. The wireless network 100 can include any number of gNBs and UEs in any suitable arrangement, and the gNB 101 can directly communicate with any number of UEs and provide wireless broadband access to the network 130 for those UEs. Similarly, each gNB 102 and 103 can directly communicate with the network 130 and provide direct wireless broadband access to the network 130 for the UEs. The gNB 101, 102 and/or 103 can provide access to other or additional external networks, such as external telephone networks or other types of data networks.

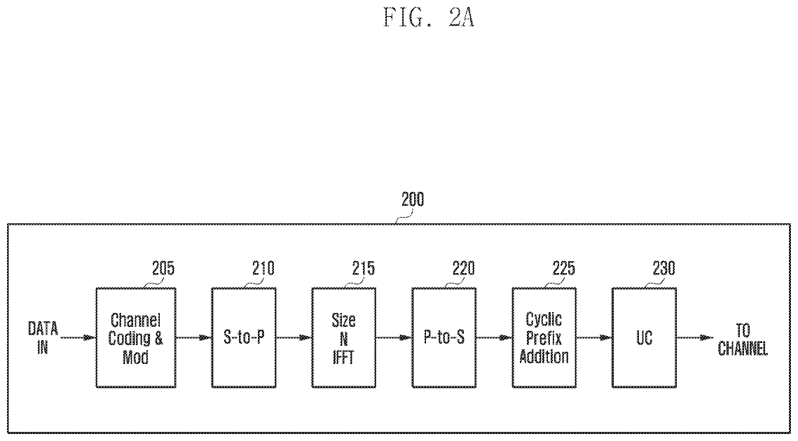

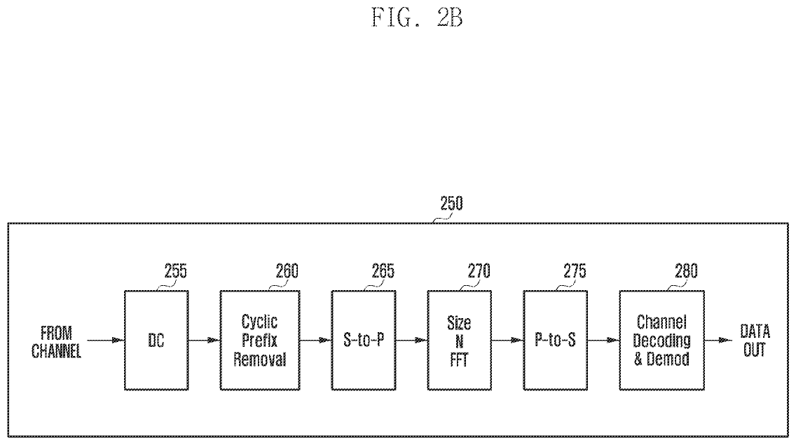

FIG. 2A illustrates a wireless transmission path 200 according to an embodiment. FIG. 2B illustrates a wireless reception path 250 according to an embodiment.

Referring to FIG. 2A, the transmission path 200 is implemented in a gNB, such as gNB 102. In FIG. 2B, the reception path 250 is implemented in a UE, such as the UE 116. However, it is noted that the reception path 250 can be implemented in a gNB and the transmission path 200 can be implemented in a UE. The reception path 250 is configured to support codebook designs and structures for systems with 2D antenna arrays as described herein.

In FIG. 2A, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. in FIG. 2B, the reception path 250 includes a down-converter (DC) 255, a cyclic prefix removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The S-to-P block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (or up-converts) the output of the cyclic prefix addition block 225 to radio frequency (RF) for transmission via a wireless channel. The signal can also be filtered at a baseband before switching to the RF frequency.

The RF signal transmitted from gNB 102 arrives at the UE 116 after passing through the wireless channel, and operations in reverse to those at gNB 102 are performed at the UE 116. in FIG. 2B, the down-converter 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101, 102 and 103 may implement a transmission path 200 similar to that for transmitting to UEs 111, 112, 113, 114, 115 and 116 in the downlink, and may implement a reception path 250 similar to that for receiving from UEs 111, 112, 113, 114, 115 and 116 in the uplink. Similarly, each of UEs 111, 112, 113, 114, 115 and 116 may implement a transmission path 200 for transmitting to the gNBs 101, 102 and 103 in the uplink, and may implement a reception path 250 for receiving from the gNBs 101, 102 and 103 in the downlink.

Each of the components in FIGS. 2A and 2B can be implemented using only hardware or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and other types of transforms can be used, such as discrete Fourier transform (DFT) and inverse DFT (IDFT) functions. 12or DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B illustrate examples of types of transmission and reception paths capable of being used in a wireless network. Any other suitable architecture can be used to support wireless communication in a wireless network.

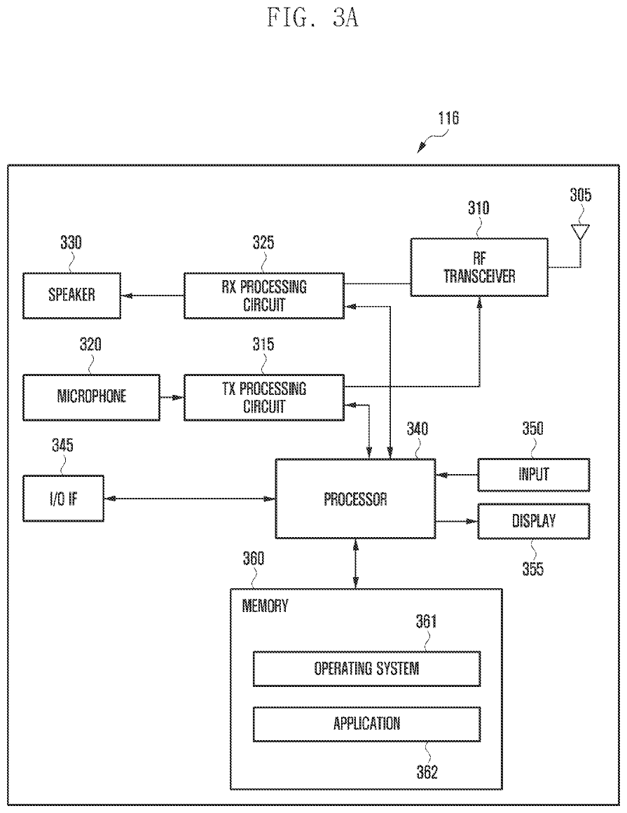

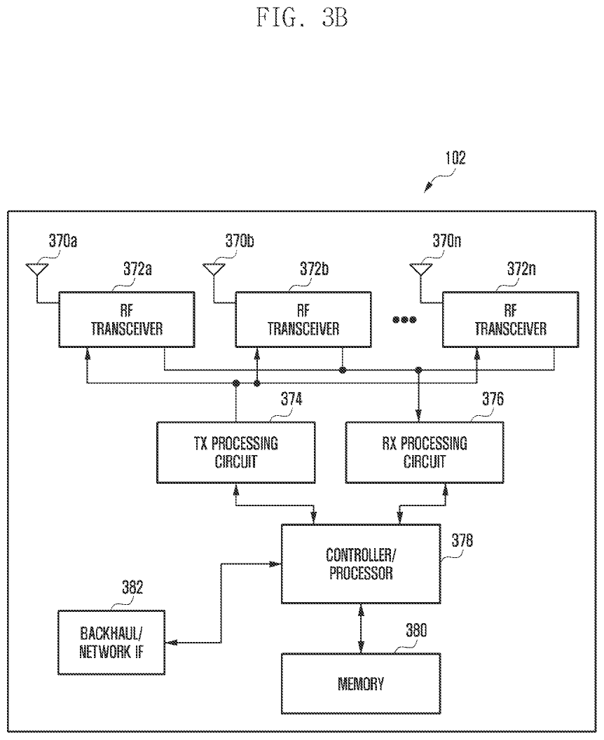

FIG. 3A illustrates a UE 116 according to an embodiment. The embodiment of the UE 116 shown in FIG. 3A is for illustration purposes only, and UEs 111, 112, 113, 114 and 115 of FIG. 1 can have the same or similar configuration. The UE 116 in FIG. 3A is not limited to any specific implementation.

Referring to FIG. 3A, the UE 116 includes an antenna 305, an RF transceiver 310, a transmission (TX) processing circuit 315, a microphone 320, a reception (RX) processing circuit 325, a speaker 330, a processor/controller 340, an input/output (I/O) interface (IF) 345, an input device(s) 350, a display 355, and a memory 360including an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency or baseband signal which is transmitted to the RX processing circuit 325, where the RX processing circuit 325 generates a processed baseband signal by filtering, decoding and/or digitizing the baseband or Intermediate frequency signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or Intermediate frequency signal. The RF transceiver 310 receives the outgoing processed baseband or Intermediate frequency signal from the TX processing circuit 315 and up-converts the baseband or Intermediate frequency signal into an RF signal transmitted via the antenna 305.

The processor/controller 340 can include one or more processors or other processing devices and executes an OS 361 stored in the memory 360 to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. The processor/controller 340 includes at least one microprocessor or microcontroller.

The processor/controller 340 is also capable of executing other processes and programs residing in the memory 360, such as operations for channel quality measurement and reporting for systems with two-dimensional (2D) antenna arrays as described herein. The processor/controller 340 can move data into or out of the memory 360 as required by an execution process. The processor/controller 340 is configured to execute the application 362 based on the OS 361 or in response to signals received from the gNB or the operator. The processor/controller 340 is also coupled to the I/O interface 345 which provides UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash or read-only memory (ROM).

Although FIG. 3A illustrates an example of the UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs may be configured to operate as other types of mobile or fixed devices.

FIG. 3B illustrates an example gNB 102 according to an embodiment. However, the gNB 102 in FIG. 3B is not limited to any specific implementation.

Referring to FIG. 3B, the gNB 102 includes a plurality of antennas 370a-370n, a plurality of RF transceivers 372a-372n, a TX processing circuit 374, and an RX processing circuit 376. One or more of the plurality of antennas 370a-370n include a 2D antenna array. The gNB 102 also includes a controller/processor 378, a memory 380, and a backhaul or network interface 382.

The RF transceivers 372a-372n receive an incoming RF signal from antennas 370a-370n, such as a signal transmitted by UEs or other gNBs. RF transceivers 372a-372n down-convert the incoming RF signal to generate an intermediate frequency or baseband signal that is transmitted to the RX processing circuit 376, where the RX processing circuit 376 generates a processed baseband signal by filtering, decoding and/or digitizing the baseband or Intermediate frequency signal. The RX processing circuit 376 transmits the processed baseband signal to controller/processor 378 for further processing.

The TX processing circuit 374 receives analog or digital data (such as voice data, network data, email or interactive video game data) from the controller/processor 378and encodes, multiplexes and/or digitizes outgoing baseband data to generate a processed baseband or Intermediate frequency signal. The RF transceivers 372a-372n receive the outgoing processed baseband or Intermediate frequency signal from TX processing circuit 374 and up-convert the baseband or Intermediate frequency signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm and decode a received signal from which an interference signal is subtracted. A controller/processor 378 may support any of a variety of other functions in the gNB 102 and includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays, supports communication between entities such as web real-time communications (RTCs), and moves data into or out of the memory 380 as required by an execution process.

The controller/processor 378 is also coupled to the backhaul or network interface 382 which enables the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an ethernet or an RF transceiver.

The memory 380 is coupled to the controller/processor 378. A part of the memory 380 can include a RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

The transmission and reception paths of the gNB 102 (implemented using RF transceivers 372a-372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. The access point can include many backhaul or network interfaces 382, and the controller/processor 378 can support routing functions to route data between different network addresses. Although shown as including a single instance of the TX processing circuit 374 and a single instance of the RX processing circuit 376, the gNB 102 can include multiple instances of each (such as one for each RF transceiver).

A time domain unit (or time unit) herein may be an OFDM symbol, an OFDM symbol group composed of multiple OFDM symbols, a time slot, a time slot group composed of multiple time slots, a subframe, a subframe group composed of multiple subframes, a system frame and a system frame group composed of multiple system frames; or may also be an absolute time unit, such as 1 millisecond, 1 second, or may also be a combination of various granularities, such as N1 time slots plus N2 OFDM symbols.

A frequency domain unit (or frequency unit) herein may be a subcarrier, a subcarrier group composed of multiple subcarriers, a resource block RB which may also be called a physical resource block PRB, a resource block group composed of multiple RBs, a bandwidth part BWP, and a bandwidth part group composed of multiple BWPs; or may also be an absolute frequency domain unit, such as 1 Hz, 1 kHz, or may also be a combination of various granularities, such as M1 PRBs plus M2 subcarriers.

The transmission link of wireless communication system mainly includes a downlink communication link from 5G gNB to a UE and uplink communication link from the UE to a network.

Nodes used for positioning measurement in wireless communication systems, such as current wireless communication systems, may include a UE that initiates a positioning request message, a location management function (LMF) used for UE positioning and sending positioning assistance data, a base station device (e.g., gNB or TRP) that broadcasts positioning assistance data and performs uplink positioning measurement, and a UE used for downlink positioning measurement. The method disclosed herein can also be applied to other communication systems, such as automobile communication (V2X), such as sidelink communication, in which the transmission-reception point or UE may be any type of device in V2X.

method for positioning may be used not only for calibrating synchronization errors, but also for other purposes such as positioning reference units enabled for positioning measurement when the network condition improves or worsens. In turn, synchronization can be calibrated by utilizing more detailed positioning-related information. The positioning-related information obtained by utilizing the location reference units may be used to adjust the network, thereby optimizing the network performance.

Based on the method provided herein, a UE can determine whether it is capable of acting as a positioning reference unit (PRU) and providing positioning reference service. The system device performs a specific operation (e.g., calibration operation or synchronization operation, including calibration of time synchronization error and phase synchronization error, for example) by utilizing a PRU that meets certain conditions. While a synchronous operation or a calibration operation will be described as an example of this specific operation, the method may be applied to other operations that the base station can perform by utilizing positioning information.

During performing a calibration operation, a UE needs to determine positioning reference signal resources, measurement methods, feedback methods, etc. for the calibration operation.

Herein, some aspects of a method and device for positioning will be introduced. The present disclosure utilizes a PRU to feed back some results of measurements or send some reference signals, so as to improve the positioning performance by improving the time synchronization and/or phase synchronization between TRPs or base stations. The method herein is described in terms of a network device, which may be replaced by a TRP device or other device. Specifically, the method herein comprises at least one of

identification of a PRU, which includes identifying that a device is a positioning reference unit and/or determining that a device is in a state in which a condition for acting as a positioning reference unit is met (e.g., some indication information of the device indicates a specific value). For example, a device may be identified as a positioning reference unit in one or more of the following cases, or the following devices may be identified as positioning reference units.

The device designated by the base station device acts as a positioning reference unit.

The UE informs the base station device that it is capable of acting as a positioning reference unit and/or that it meets the condition for acting as a positioning reference unit, through signaling reporting (e.g., some indication information of this UE indicates a true value); The signaling may be via physical layer signaling (such as uplink control information (UCI) carried by a physical uplink control channel (PUCCH), medium access control control element (MAC CE) and/or higher layer signaling.

The UE or other device that meets the condition for acting as a positioning reference unit.

The UE or other device whose state (e.g., the state may be a type of indication information, such as a flag, an indicator, etc.) related to meeting the condition for acting as a positioning reference unit is true (e.g., true, or on) or not false (e.g., false or off), wherein the state related to meeting the condition for acting as a positioning reference unit being true or not false includes at least one of the condition for acting as a positioning reference unit is met for N1 number of times or for N1 number of times consecutively, or the condition for acting as a positioning reference unit is met within N4 time units or within N4 consecutive time units.

If at least one of the above conditions is not met, the state related to meeting the condition for acting as a positioning reference unit is considered as not true or false, or the value of N1 or N3 may be a positive integer configured by the network device and/or predefined, or N1 or N3 may be 1.

The condition for acting as a positioning reference unit include at least one of the device as known location information that meets certain requirements including location information that has passed the integrity requirement and/or location information for which the positioning error is less than a first threshold value configured by the network device and/or predefined.

The value of reference signal received power (RSRP), and/or reference signal received quality (RSRQ), and/or pathloss of the reception of the downlink reference signal by the device are greater than a second threshold value. The downlink reference signal may be a synchronization signal block (SSB) and a physical broadcast channel (PBCH) block and/or channel state information-reference signal (CSI-RS) and/or positioning reference signal (PRS); The second threshold value may be a threshold value configured by the network device and/or predefined. In this manner, the UE with better channel conditions can provide services of a positioning reference unit, and the associated measurement will be more accurate.

Conditions for enabling a PRU, include at least one of enabling triggered based on event, enabling based on periodicity, or enabling triggered based on condition.

Enabling triggered based on event, includes enabling the positioning reference unit to perform associated operations when at least one of the following events occurs.

The LMF instructs one or more base stations to perform calibration operation, or a synchronization operation including time synchronization and/or phase synchronization.

A time synchronization timer and/or a phase synchronization timer between base stations expire; Time synchronization can be extended to other operations. For example, when the time synchronization operation between two base station devices is completed, the time synchronization timer starts until the timer reaches or exceeds a third threshold value, and it is determined that the time synchronization timer expires. The third threshold value may be configured by the network device and/or predefined.

A time synchronization counter and/or a phase synchronization counter between base stations is greater than a fourth threshold value. This event may also be that the time synchronization counter and/or the phase synchronization counter between base stations plus one is equal to the fourth threshold value configured by the network device and/or predefined.

When the base station and/or UE receive an indication that the positioning performance is poor from the higher layer, and

When the resulting information from integrity calculation performed on the location information by the base station and/or the UE does not meet the requirements, such as when the calculated integrity-related value is less than a fifth threshold value within a certain period of time, wherein the fifth threshold value is configured by the network device and/or predefined.

Enabling based on periodicity includes enabling the positioning reference unit to perform associated operations according to a certain length of periodicity that is at least one of the periodicity length configured by LMF and/or configured by base station device and/or requested by UE, and the least common multiple for periodicities of downlink reference signals between one or more base stations requiring synchronous operation. The downlink reference signals may be SSB and/or CSI-RS and/or PRS; In this way, the certain length of periodicity can be divided evenly by the lengths of periodicities of all base stations requiring synchronization operation, and thus any ambiguity of the periodicity of resources due to the split periodicity will not occur.

The least common multiple for the periodicities may further include the least common multiple between the periodicity of the downlink reference signals among one or more base stations and the periodicity in which the UE performs measurement of the downlink reference signal.

Enabling triggered based on a condition, including enabling the positioning reference unit to perform associated operations when at least one of the following conditions is met.

When there are N2 identified positioning reference units and/or identified devices whose state related to meeting the condition for acting as a positioning reference unit is a specific value (e.g., true).

When among identified positioning reference units and/or identified devices whose state related to meeting the condition for acting as a positioning reference unit is a specific value (e.g., true), the number of the devices meeting the following conditions is one or more, or equal to N5, or all of these devices, a first list of base stations or cells corresponding to the device includes or is equivalent to each base station or cell in a list of base stations or cells requiring calibration (or synchronization) operation (or a second list of base stations or cells). The first list of base stations or cells includes the base stations or cells that the device needs to measure, that serve the device, that the device needs to measure, or that the device is allowed to add, modify or remove. The first list of base stations or cells may be configured via higher layer signaling or physical layer signaling or preconfigured. The first list of base stations or cells may include a list of cell identifiers (IDs), a list of physical cell IDs, a range of cell IDs, or a preconfigured list of indices. In an implementation, the second list of base stations or cells may require calibration (or synchronization) operations. For example, base stations 1, 2 and 3 are required to perform synchronous operation, and there are five identified PRUs in total, in which PRU1 can receive signals from base stations 1, 2, 3 and 4 (e.g., the first list of base stations or cells for PRU1 includes base stations 1, 2, 3 and 4), PRU2 can receive signals from base stations 1, 3 and 4 (e.g., the first list of base stations or cells for PRU2 includes base stations 1, 3 and 4), PRU3 can receive signals from base stations 1, 2 and 3 (e.g., the first list of base stations or cells for PRU3 includes base stations 1, 2 and 3), PRU4 can receive signals from base stations 1, 2, 3 and 4 (e.g., the first list of base stations or cells for PRU4 includes base stations 1, 2, 3 and 4), and PRU5 can receive signals from base stations 1, 2, 3 and 4 (e.g., the first list of base stations or cells for PRU5 includes base stations 1, 2, 3 and 4), and N5=3 in the triggering condition. There are 4 (which is more than N5=3) PRUs with the first list of base stations or cells including at least each base station (base stations 1, 2 and 3) in the list of base stations requiring synchronization at this time, so it is determined that the enabling condition is met. The first list of base stations or cells for the device may be reported by the device to the base station device or LMF, may be configured for the UE by the base station device or LMF, or may be a list of base stations indicated by preconfigured indices.

Operation of PRU use may include at least one of receiving and/or obtaining the configuration for positioning reference signal, comprising the PRU receives configuration information for positioning reference signal from the base station device or configured by the LMF, and the positioning reference signal includes downlink positioning reference signals (including SSB, CSI-RS and PRS) and/or uplink reference signals for positioning (including at least SRS for positioning). The positioning reference signal is for synchronization. The configuration information at least includes at least one of a periodicity of the reference signal, a time domain location (such as a starting location of the time domain unit, a time domain gap from the reference point, a number of time domain units occupied, etc.), a number of repetitions in time domain, and frequency domain location (such as a starting location of the frequency domain unit, a number of frequency domain units occupied, etc.).

The PRU receives a positioning reference signal configuration index indicated by the base station device or LMF.

The PRU receives a positioning reference signal mask index indicated by the base station device or LMF, the mask index may indicate that one or more of the configured positioning reference signals are used for synchronization operations supported by the PRU. The one or more configured positioning reference signals may be within a certain time range, which includes a positioning reference signal periodicity and/or a measurement periodicity or a separately defined time domain gap or time domain window. The mask index may be directly a positioning reference signal index or a row index of Table 1 below, wherein each row includes one or more positioning reference signal indices. As shown in Table 1, the mask is 3 bits, indicating 8 possible positioning reference signal indices, and there are 4 positioning reference signals (PRS0, 1, 2 and 3) in one positioning reference signal periodicity.

TABLE 1

| Mask Index | PRS Index |
|---|---|
| 0 | PRS0 |
| 1 | PRS1 |
| 2 | PRS2 |
| 3 | PRS3 |
| 4 | odd PRS indices |
| 5 | even PRS indices |
| 6 | all PRSs |
| 7 | reserved |

Table 1 is only an example, which can be extended to different mask bit values and/or different positioning reference signal index values.

The positioning reference unit receives and measures or sends a positioning reference signal. At least one of the following items may be included.

The PRU performs reception, measurement or transmission of the positioning reference signal according to the obtained positioning reference signal configuration, and the PRU receives a trigger indication from base station device or LMF, and then performs reception and measurement or transmission of the positioning reference signal. The trigger indication may be via higher layer signaling, DCI or MAC CE. The above configuration information for positioning reference signal may be carried in the trigger indication. The PRU may start to perform reception and measurement or transmission of the positioning reference signal only after N3 time units after receiving the trigger indication. The PRU may not start to perform reception and measurement or transmission of the positioning reference signal until the first positioning reference signal after N3 time units after receiving the trigger indication.

The report of the results of measurements specifically includes at least one of the results of measurements of the PRU, which include RSRP, and/or RSRQ, and/or pathloss, and/or time of arrival (TOA), time difference of arrival (TDOA), and/or phase of arrival (POA) and phase difference of arrival (PDOA) of a positioning reference signal. The positioning reference signal may be aimed at a path, or the first path of arrival in time, or a path with the strongest amplitude, of a positioning reference signal.

The PRU feeds back the result of measurements to the network device according to a configured reporting periodicity.

When certain conditions are met, the PRU feeds back the results of measurements to the network device according to the configured reporting periodicity, wherein the certain conditions include when the results of measurements of RSRP and/or RSRQ and/or Pathloss are equal to a sixth threshold value, or when there are no less than or more than N3 results of measurements, when the result of measurements of TOA and TDOA are equal to a seventh threshold, or when there are N3 results of measurements (the sixth threshold value and/or the seventh threshold value, and the fifth threshold value may be configured by the network device and/or predefined).

When the PRU is within a window of the measurement, when a state meeting the condition for acting as a positioning reference unit becomes false and/or the condition for acting as a positioning reference unit is not met, the PRU may perform at least one of stopping the measurement, directly closing the window of the measurement, and/or not extending the window of the measurement, feeding back the existing result of the measurement to the network device, or dropping the existing result of the measurement.

The result of the measurement is when the above conditions are met.

After the result of the measurement is obtained according to the above method, the network side may obtain a result related to the synchronization or calibration operation. The following is an example of synchronization operation and is not intended to be limiting. Rather, the following methods can also be applied to calibration operation or other operations between base stations. The notification of the results related to the synchronization operation may include at least one of when the LMF obtains synchronization error information (time synchronization error and/or phase synchronization error) between base stations, the LMF informs a corresponding base station device and/or UE of the obtained synchronization error information, the base station device informs the UE of the obtained synchronization error information, or the UE obtains the synchronization error information of the base station and compensates it into the measurement (e.g. into TOA, TDOA, POA and PDOA resulting from the downlink positioning reference signal) or transmission (e.g. into a value of timing advance of the uplink transmission) of the positioning reference signal by the UE.

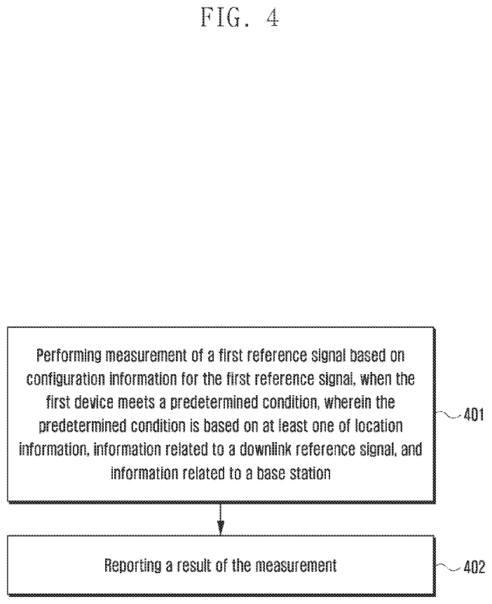

FIG. 4 illustrates a flowchart for a method of positioning by a device, according to an embodiment.

Referring to FIG. 4, in step 401, the device performs measurement of a first reference signal based on configuration information for the first reference signal, when the first device meets a predetermined condition based on at least one of location information, information related to downlink reference signals, and information related to base stations.

In step 402, the device reports a result of the measurement.

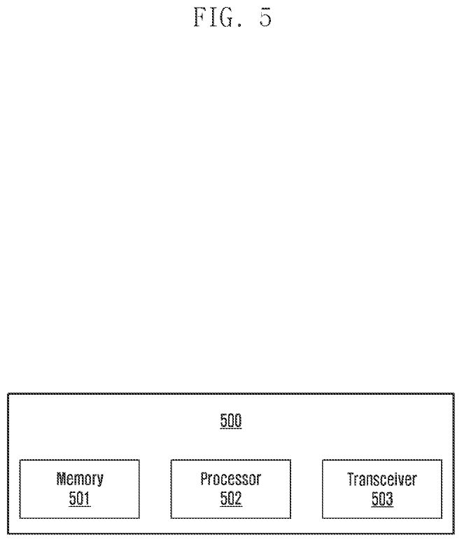

FIG. 5 illustrates a device 500 in a communication system according to an embodiment.

Referring to FIG. 5, the device 500 includes a memory 501, a processor 502 and a transceiver 503. The memory 501 has computer-executable instructions stored thereon, and when being executed by the processor 502, the instructions cause at least one method corresponding to the above embodiments to be executed. This is only an example, however, and is not used to limit the present disclosure.

The devices disclosed herein may be specially designed and manufactured for required purposes, or may also include known devices in general-purpose computers. These devices have computer programs stored therein, which are selectively activated or reconfigured. Such a computer program may be stored in a device (e.g., a computer) readable medium, or be stored in any type of medium suitable for storing electronic instructions and respectively coupled to a bus. The computer readable medium includes but not limited to any type of disk (including floppy disk, hard disk, optical disk, compact disc ROM (CD-ROM), and magneto-optical disk), ROM, RAM, erasable programmable read-only memory (EPROM), electrically erasable programmable read-only memory (EEPROM), flash memory, magnetic card or optical card. That is, the readable medium includes any medium in which information is stored or transmitted by a device (e.g., a computer) in a readable form.

Each block in these structural diagrams and/or block diagrams and/or flow diagrams and combinations of blocks in these structural diagrams and/or block diagrams and/or flow diagrams may be implemented in computer program instructions. These computer program instructions may be provided to a processor of a general-purpose computer, a professional computer or other programmable data processing methods for implementation, so that the scheme specified in the block or blocks of the structure diagram and/or block diagram and/or flow diagram disclosed in the present invention may be executed by the processor of the computer or other programmable data processing methods.

The steps, measures and schemes in various operations, methods and flows that have been discussed herein may be alternated, modified, combined or deleted. Other steps, measures and schemes in the various operations, methods and flows that have been discussed herein may also be alternated, altered, rearranged, decomposed, combined or deleted.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a first device in a communication system, the method comprising:
performing measurement of a first reference signal based on configuration information for the first reference signal, when the first device meets a predetermined condition; and
reporting a result of the measurement,
wherein the predetermined condition is based on at least one of location information, information related to downlink reference signals, and information related to at least one base station.

2. The method of claim 1, wherein the configuration information for the first reference signal includes information on at least one of:
a periodicity of the first reference signal,
a time domain location of the first reference signal,
a number of repetitions in the time domain for the first reference signal,
a frequency domain location of the first reference signal,
index information of the first reference signal, and
mask index information indicating the first reference signal.

3. The method of claim 2,
wherein the first reference signal is within a first time range including at least one first reference signal periodicity, at least one measurement periodicity, or at least one time gap.

4. The method of claim 1, further comprising receiving first indication information used to trigger the first device to perform measurement of the first reference signal.

5. The method of claim 4,
wherein the first device performs measurement of the first reference signal after a third time gap after receiving the first indication information.

6. The method of claim 1, wherein the result of the measurement includes information on at least one of the following of the first reference signal:
reference signal received power (RSRP),
reference signal received quality (RSRQ),
path loss,
time of arrival (TOA),
time difference of arrival (TDOA),
phase of arrival (POA), and
phase difference of arrival (PDOA).

7. The method of claim 6,
wherein the information included in the result of the measurement is first reference information on one path, the first path of arrival, or a path with a strongest amplitude.

8. The method of claim 6, wherein the predetermined condition includes at least one of:
the first device being designated as a positioning reference unit (PRU) by a base station,
the first device reporting that the first device can act as a positioning reference unit PRU,
indication information that the first device meets a second condition being reported,
the first device meeting the second condition,
second indication information related to the first device indicating a first value,
occurrence of a first event,
the positioning reference unit being enabled based on a first periodicity, and
a third condition being met.

9. The method of claim 8, wherein the second condition includes at least one of:
the location information of the first device meeting an integrity requirement and/or a positioning error being less than or equal to a first threshold, and
at least one of the RSRP, the RSRQ, or the path loss of reception of a downlink reference signal by the first device meeting a second threshold.

10. The method of claim 8, wherein the second indication information indicates the first value in at least one of:
when a number of times where the first device meets the second condition reaches a first number, and
when the first device meets the second condition within a second number of time units.

11. The method of claim 8, wherein the first event includes at least one of:
the base station being indicated to perform synchronization or calibration operation,
a synchronization timer between base stations expires,
a count value of the synchronization counter between base stations reaches a fourth threshold,
the base station or the first device receives information indicating poor positioning performance, and
integrity of the location information of the base station or the first device not meeting a fifth threshold.

12. The method of claim 8, wherein a length of the first periodicity includes at least one of:
a configured periodicity length,
a periodicity length requested by the first device,
the least common multiple for periodicities of the downlink reference signals of the base station, and
the least common multiple for the periodicities of the downlink reference signals of the base station and a periodicity in which the first device performs measurement of the downlink reference signal.

13. The method of claim 8, wherein the third condition includes at least one of:
a number of devices capable of being used as positioning reference units being greater than or equal to a third number, and
a number of third devices among devices capable of being used as positioning reference units being greater than or equal to a fourth number,
wherein a first list of base stations or cells corresponding to the third devices includes each base station or cell in a second list of base stations or cells related to the base station.

14. The method of claim 13,
wherein the first list of base stations or cells includes base stations or cells to be measured by the first device, base stations or cells serving the first device, or a pre-configured list of the base stations or cells.

15. The method of claim 8,
wherein, during the measurement of the first reference signal, if the predetermined condition is no longer met, the first device performs at least one of:
stopping the measurement,
closing or not extending the measurement window,
sending a result of a performed measurement to a network, and
dropping a result of a performed measurement.

16. The method of claim 1, further comprising:
receiving error information related to calibration or synchronization based on the result of the measurement from one or more of the base stations; and
compensating for the measurement of the first reference signal according to the error information related to calibration or synchronization.

17. A method performed by a second device in a communication system, the method comprising:
sending configuration information for a first reference signal to at least one first device meeting a predetermined condition; and
receiving a result of measurement of the first reference signal from one or more of the at least one first devices,
wherein the predetermined condition is based on at least one of location information, information related to downlink reference signals, and information related to at least one base station.

18. The method of claim 17, wherein the predetermined condition includes at least one of:
the first device being designated as a positioning reference unit (PRU),
information that the first device can act as the PRU or that the first device meets a second condition being reported,
the first device meeting the second condition,
second indication information related to the first device indicating a first value,
occurrence of a first event occurs,
the positioning reference unit being enabled based on a first periodicity, and
a third condition being met.

19. The method of claim 18, wherein the second condition includes at least one of:
the location information of the first device meeting an integrity requirement and/or a positioning error being less than or equal to a first threshold, and
at least one of a reference signal received power, reference signal received quality, or path loss of reception of a downlink reference signal by the first device meeting a second threshold.

20. A device in a communication system, the device comprising:
a transceiver; and
a processor coupled to the transceiver and configured to perform a method in a communication system, the method including:
sending, via the transceiver, configuration information for a first reference signal to at least one first device meeting a predetermined condition; and
receiving, via the transceiver, a result of measurement of the first reference signal from one or more of the at least one first devices,
wherein the predetermined condition is based on at least one of location information, information related to downlink reference signals, and information related to at least one base station.
